(19) United States
(12) Patent Application Publication
(10) Pub. No.: US 2005/0114499 A1
(43) Pub. Date: May 26, 2005

(54) System and method for updating testing devices in a distributed environment

(76) Inventor: John M. Monk, Monument, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/718,522

(22) Filed: Nov. 24, 2003

(51) Int. Cl. G06F 15/173; G06F 15/16

(52) U.S. Cl. 709/224; 709/223; 709/202

(57) ABSTRACT

A distributed testing device system, including a user interface, a server communicating with the user interface, and at least one distributed testing device communicating with the server, wherein a user selects at least one distributed testing device for an update via the user interface and the server communicates with the selected at least one distributed testing device to download the update from the server and execute the update on said at least one distributed testing device.

### CROSS-REFERENCE TO RELATED APPLICATIONS

The present invention relates to patent application titled “Distributed Testing System Having Framework For Adding Measurements and Physical Agents,” inventors John M. Monk et al., Attorney Docket No.: PDNO. 10030705-1, filed on Nov. 19, 2003, which is incorporated herein by reference.

### BACKGROUND OF THE INVENTION

1. Field of the Invention

The present invention relates to a system and method for updating testing devices and, more particularly, to a system and method for updating testing devices in a distributed environment.

2. Description of the Related Art

As new versions of software are periodically released, there is a need to update distributed testing devices with the new software. Traditionally, a technician would travel to the testing device and install the appropriate update or software program and/or components necessary for the local operation software program on the testing device.

As technology has improved, producers of software programs distribute their products on high-capacity media such as diskettes, or compact discs (CD). These software programs comprise a collection of independent modules that provide different functionality or serve to tailor the software program to a particular environment. Therefore, a tailored software program is assembled on the end user computer system.

Modern solutions tend to rely on file transfer protocol (FTP) type mechanisms for updating distributed testing devices. These methods tend to either pull, or push update files to the intended location.

However, if many testing devices are distributed over a large geographical area, it is impractical to update the testing devices through the traditional methods discussed above. For example in the more modern solutions, it is necessary for a user to log onto the distributed testing device and then download or push the file. Accordingly, not only does such types of updates require that the user have an understanding of the program but it also slows down the update process.

### SUMMARY OF THE INVENTION

Accordingly, the present invention provides a system and method for updating testing devices in a distributed environment quickly and efficiently.

The present invention also provides a system and a method that allows multiple distributed testing devices to be administered individually, or as a group.

The present invention also provides a system and method that allows the multiple distributed testing devices to be updated serially, or in parallel. Therefore, it is possible to simultaneously update a large number of distributed testing devices.

The present invention also provides a system and method that allows a large number of testing devices to asynchronously pull their software update files from a server. Accordingly, the testing devices do not need to keep track of the location of the server.

The present invention also provides a system and method for integrating new testing devices, servers and graphic user interfaces as they become necessary.

Additional objects and advantages of the invention will be set forth in part in the description which follows, and, in part, will be obvious from the description, or may be learned by practice of the invention.

The present invention provides a system including a user interface, a server communicating with the user interface, and at least one distributed testing device communicating with the server, wherein a user selects at least one distributed testing device for an update via the user interface and the server communicates with the selected at least one distributed testing device to download the update from the server and execute the update on said at least one distributed testing device.

The present invention also provides a method for remotely updating distributed testing devices, including remotely selecting at least one distributed testing device for an update process via a interface unit, initiating the update process via a server by notifying the selected at least one distributed testing device that the update process is required, and executing the update process on the at least one distributed testing device.

The present invention also provides a distributed testing apparatus including a graphic user interface (GUI), a server communicating with the GUI, and at least one distributed testing device communicating with the server, to perform a testing of a network in accordance with control by an end user via the GUI, wherein a user selects at least one distributed testing device for an update via the user interface and the server communicates with the selected at least one distributed testing device to download the update from the server and executes the update on said at least one distributed testing device.

Moreover, the present invention provides a method for updating testing devices in a network, including selecting a testing device, for an update package, in the network via a user interface and submitting an update request to a server, notifying the selected testing device via the server that the update package is required, receiving the notification at the selected testing device and submitting an acknowledgment to the server, downloading to the selected testing device the update package from the server after submitting the acknowledgment to the server and notifying the server a download status of the update package, preparing the update package for execution at the selected testing device after downloading the update package from the server and notifying the server a preparation status of the update package, executing the update package at the selected testing device after preparing the update package and notifying the server an execution status of the update package.

### BRIEF DESCRIPTION OF THE DRAWINGS

These and/or other objects and advantages of the invention will become apparent and more readily appreciated from the following description of the preferred embodiments, taken in conjunction with the accompanying drawings of which:

FIG. 1 is a diagram illustrating a system, according to an embodiment of the present invention.

FIG. 2 is a flow chart illustrating the communications between the components of the system in FIG. 1, according to an embodiment of the present invention.

FIG. 3 is a diagram illustrating the screen of a client graphic user interface (GUI), according to an embodiment of the present invention.

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

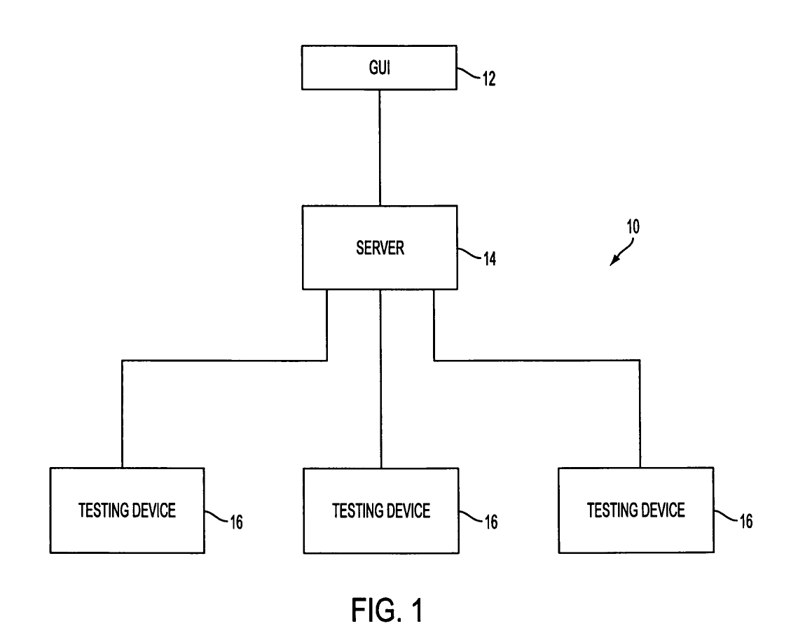

FIG. 1 is a diagram illustrating a system 10 for performing measurements or tests of a network, according to an embodiment of the present invention. Referring to FIG. 1, the system 10 includes a user interface 12, a server 14 communicating with the user interface 12, and distributed testing devices 16 communicating with the server 14. User interface 12 would typically be, for example, a graphical user interface (GUI)

With system 10, an end user uses user interface 12 to control testing devices 16 via server 14, to perform measurements or tests of a network (not shown). Further details of a system, such as system 10, to perform measurements or tests of a network would be understood from Patent Application titled “Distributed Testing System Having Framework For Adding Measurements and Physical Agents,” inventors John M. Monk et al., Attorney Docket No.: PDNO. 10030705-1, filed on Nov. 19, 2003, which is incorporated herein by reference.

With system 10, software on distributed testing devices 16 can be updated in an efficient and effective manner. More specifically, referring to FIG. 1, to update software on distributed testing devices 16, a user selects which of the distributed testing devices 16 are to be update via the user interface 12. The server 14 communicates with the selected distributed testing devices 16 to download the update from the server 14 and executes the update on the selected distributed testing devices 16. The update of the present invention includes, for example, an update package (not shown) located in the server 14.

The server 14 might be a Network Troubleshooting Center (NTC) operating as a server. An NTC is a known device and might be, for example, an Agilent™ NTC such as, for example, an Agilent™ Model No. J6801A. Therefore, in this example, user 12 would be a GUI for the NTC. The testing device 16 might be, for example, a Network Analyzer (NA). An NA is a known device and might be, for example, an Agilent™ NA, such as an Agilent™ Model No. J6801A. However, the present invention is not limited to the server 14 being an NTC, to user interface 12 being a GUI for an NTC, or to a testing device 16 being an NA. Instead, there are many different types of computers and apparatuses that can operate as a server or testing device in the system 10. Moreover, there are many different types of GUIs that can be used in the system 10. Accordingly, the present invention provides a framework for integrating more components, such as GUIs, servers and testing devices, as necessary.

Generally, “distributed” indicates that the testing devices might be in very different, remote locations connected to different points in a network. As an example, a server might be located in Denver, Colo., and the testing devices connected to the server might be located in New York, N.Y., and in Chicago, Ill. As an additional example, the server and testing devices might be located in different buildings, or simply in different rooms of the same building. The concept of “distributed” would be well understood by a person of ordinary skill in the art.

As indicated above, the present invention relates to performing measurements or tests of a network. The present invention is not limited to any particular type of network or any particular type of network protocols or technology. For example, a network might be based on, or be a combination of, wired, wireless, optical, circuit-switched, packet and/or voice-over-Internet Protocol (VOIP) technologies. A network might be, for example, a public, private or combination public/private network. A network might be or include, for example, the Internet.

Moreover, FIG. 1 shows only one user, one server and three distributed testing devices. However, the present invention is not limited to this specific configuration. Instead, for example, there may be virtually any number of testing devices, any number of servers and/or any number of user interfaces, in accordance with general client/server and distributed system designs, as would be understood by a person of ordinary skill in the art.

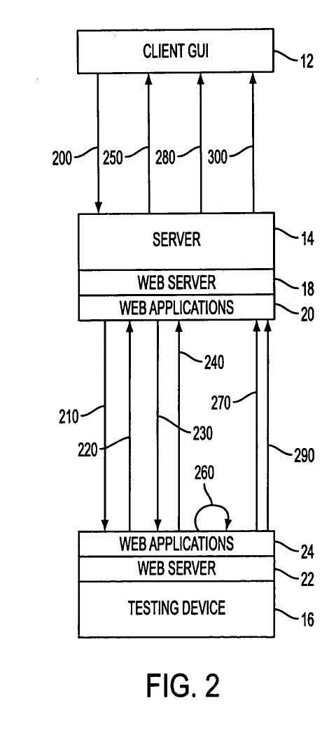

FIG. 2 is a flow chart illustrating the operations taking place between the components of the system.

Referring now to FIG. 2, the server 14 is a central component of the system 10 and communicates with the GUI 12 and the testing device 16. Furthermore, each server 14 and each testing device 16 include a web server 18, 22 and web applications 20, 24, which are used to communicate between the server 14 and the testing device 16.

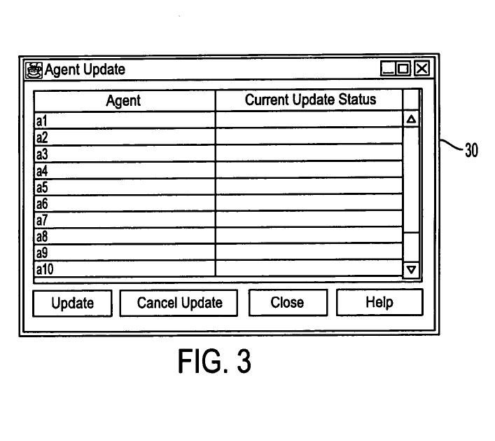

The system 10 of the present invention can comprise more than one client GUI and/or more than one server. Accordingly, the client GUI 12 illustrated in FIG. 2 may be part of other client GUIs. Additionally, the client GUIs may run on any type of hardware or may be a computer distant from the server 14. Furthermore, when the client GUI 12 communicates with the server 14, requesting an update status, the testing device 16 sends a status message to the server 14 and those messages are displayed on the client GUI 12 described later in FIG. 3.

Referring back to FIG. 2, the operations by which the testing device 16 is updated will be discussed below.

In a first operation, a user (not shown), at a client graphic user interface 12, selects a testing device 16 requiring an update and sends the request to the server 14, via communication 200. Thereafter, the server 14 initiates the update process by notifying the selected testing device 16 that an update is necessary, via communication 210.

In the next operation, the selected testing device 16 receives the communication from the server 14, and submits an acknowledgment message to the server 14, via communication 220. The selected testing device 16 then proceeds to download the installation package from the server 14, via communication 230, and sends a status update of the download to the server 14, via communication 240. In turn, the server 14 relies this information to the client graphic user interface 12, via communication 250, and displays the status of the download on the screen of the client user interface 12.

In a next operation, the testing device 16 prepares the package for installation, via communication 260, which has been downloaded from the server 14, and sends a status update of the preparation of the package to the server 14, via communication 270. The server 14 in turn relies the preparation status update to the client graphic user interface 12, via communication 280, which in turn displays the status of the preparation on the screen of the user interface 12.

In a following operation, the testing device 16, executes the installation package (not shown) downloaded from the server 14, and sends a status update of the execution package to the server 14, via communication 290. The server 14 relies this information to the client graphic user interface 12, via communication 300, which displays this information to the user on the screen of the GUI 12.

Accordingly, the user at the graphic user interface 12, views the current status of any pending updates, updates in progress and updates that have finished successfully and unsuccessfully, at the selected testing device 16.

FIG. 3 is a diagram illustrating a screen 30 of the client graphic user interface 12, according to an embodiment of the present invention. Referring now to FIG. 3, through the client GUI screen 30, a user can select one or more testing devices 16 requiring updates. Thereafter, the user can initiate an update by selecting the update icon. Similarly, the user can select one or more testing devices 16 and cancel an update by selecting the cancel update icon. Furthermore, the user can also monitor pending updates for the selected testing devices 16, updates in progress and updates that have finished successfully and unsuccessfully.

Although a few preferred embodiments of the present invention have been shown and described, it would be appreciated by those skilled in the art that changes may be made in these embodiments without departing from the principles and spirit of the invention, the scope of which is defined in the claims and their equivalents.

1. A system, comprising:
a user interface;
a server communicating with the user interface; and
at least one distributed testing device communicating with the server, wherein a user selects at least one distributed testing device for an update via the user interface and the server communicates with the selected at least one distributed testing device to download the update from the server and executes the update on said at least one distributed testing device.

2. The system according to claim 1, wherein the selected at least one distributed testing device receives an update notification from the server, and the selected at least one testing device acknowledges the update notification to the server.

3. The system according to claim 2, wherein communications between the selected at least one distributed testing device and the server comprises downloading an installation package from the server to the selected at least one testing device.

4. The system according to claim 3, wherein while downloading the installation package from the server to the selected at least one testing device, the selected at least one testing device communicates a download status update to the server.

5. The system according to claim 4, wherein after downloading the installation package from the server to the selected at least one testing device, the selected at least one testing device prepares the installation package.

6. The system according to claim 5, wherein while preparing the installation package at the selected at least one testing device, the selected at least one testing device communicates a preparation status update to the server.

7. The system according to claim 6, wherein after preparing the installation package at the selected at least one testing device, the selected at least one testing device executes the installation package.

8. The system according to claim 7, wherein while the selected at least one testing device executes the installation package, the selected at least one testing device communicates an execution status update to the server and wherein the selected at least one testing device communicates to the server a completion of the execution of the installation package.

9. The system according to claim 1, wherein the user interface comprises a client graphic user interface (GUI).

10. The system according to claim 9, wherein the GUI is a subset of other graphic user interfaces.

11. The system according to claim 1, wherein more than one distributed testing devices are updated in parallel or in serial sequence.

12. A method for remotely updating devices, comprising:
remotely selecting at least one distributed testing device for an update process via a interface unit;
initiating the update process via a server by notifying the selected at least one distributed testing device that the update process is required; and
executing the update process on the at least one distributed testing device.

13. The method according to claim 12, wherein the selected at least one distributed testing device receives a notification of the update process from the server and sends an acknowledgment of the notification to the server.

14. The method according to claim 13, wherein after receiving a notification of the update process the selected at least one distributed testing device proceeds to download from the server the update process.

15. The method according to claim 14, wherein while downloading the update process, the selected at least one distributed testing device communicates a status of the download of the update process to the server and the status of the download of the update process is displayed on the interface unit.

16. The method according to claim 15, wherein after downloading the update process, the selected at least one distributed testing device prepares the update process.

17. The method according to claim 16, wherein the selected at least one distributed testing device communicates a status of the preparation of the update process to the server and the status of the preparation of the update process is displayed on the interface unit.

18. The method according to claim 17, wherein after the preparation of the update process, the selected at least one distributed testing device executes the update process.

19. The method according to claim 18, wherein the selected at least one distributed testing device communicates, a status of the execution of the update process, to the server and the status of the execution of the update process is displayed on the interface unit.

20. The method according to claim 12, wherein the distributed testing devices are updated in serial or parallel sequence.

21. A distributed testing apparatus, comprising:
a graphic user interface (GUI);
a server communicating with the GUI; and
at least one distributed testing device communicating with the server, to perform a testing of a network in accordance with control by an end user via the GUI, wherein a user selects at least one distributed testing device for an update via the user interface and the server communicates with the selected at least one distributed testing device to download the update from the server and executes the update on said at least one distributed testing device.

22. A method for updating testing devices in a network, comprising:
selecting a testing device, for an update package, in the network via a user interface and submitting an update request to a server;
notifying the selected testing device via the server that the update package is required;
receiving the notification at the selected testing device and submitting an acknowledgment to the server;
downloading to the selected testing device the update package from the server after submitting the acknowledgment to the server and notifying the server a download status of the update package;
preparing the update package for execution at the selected testing device after downloading the update package from the server and notifying the server a preparation status of the update package;
executing the update package at the selected testing device after preparing the update package and notifying the server an execution status of the update package.
